(19) United States
(12) Patent Application Publication
(10) Pub. No.: US 2020/0013042 A1
(43) Pub. Date: Jan. 9, 2020

(54) PAYMENT SERVER, PAYMENT SYSTEM, AND CARD REGISTRATION METHOD THEREOF

(71) Applicant: SAMSUNG ELECTRONICS CO., LTD., Suwon-si, Gyeonggi-do (KR)

(72) Inventors: Ji Hye LEE, Suwon-si, Gyeonggi-do (KR); Ho Seock CHOI, Suwon-si, Gyeonggi-do (KR); Jun Ho HWANG, Seoul (KR); Bo Ram KIM, Anyang-si, Gyeonggi-do (KR); Sang Eun SHIN, Seoul (KR); Sung Jun LIM, Suwon-si, Gyeonggi-do (KR); Se Jun HAN, Yongin-si, Gyeonggi-do (KR)

(21) Appl. No.: 16/482,411

(22) PCT Filed: Mar. 2, 2018
(86) PCT No.: PCT/KR2018/002544

§ 371 Date: Jul. 31, 2019

(30) Foreign Application Priority Data
Mar. 2, 2017 (KR) 10-2017-0027128

(51) Int. Cl. G06Q 20/32; G06Q 20/34

(52) U.S. Cl. CPC G06Q 20/3226; G06Q 20/341

(57) ABSTRACT

According to various embodiments of the disclosure, a first payment server may include a communication module, and a processor to receive a card registration request including account information from a first electronic device, to request a second payment server to provide card information on a card, which is registered by a second electronic device, in association with the account information, to receive the card information from the second payment server, and to transmit, to a financial company server, the card registration request of the first electronic device based on the received card information.

### TECHNICAL FIELD

The disclosure relates to a payment server to provide an electronic payment service and a method for registering a card of a payment system.

### BACKGROUND ART

As an information technology (IT) is developed, the functions of an electronic device are advanced, and the electronic device may provide various functions for a user. The electronic device may provide a multimedia service, for example, a network-based communication service, such as a music streaming service, a video streaming service, a digital broadcast service, a call, a wireless Internet, a short message service (SMS), or a multimediamessaging service (MMS).

Recently, the combination of a finance scheme and the IT, which is so called “fin-tech”, has been spotlighted. The fields of the “fin-tech”, which is evaluated as financial paradigm shift, have been expanded to providing offline financial/settlement services and constructing financial/payment platforms, as well as conventional online financial services.

For example, manufacturers of electronic devices are making various efforts of constructing mobile payment platforms, and spreading mobile payment services by cooperating with credit card companies or banks.

### DISCLOSURE

### Technical Problem

A user needs to perform a procedure of registering a card to a server operated by a financial company issuing the card. A procedure of receiving card information from the user needs to be performed for an electronic device to register the card.

Even though the user registers the card using a specific electronic device, a procedure of inputting the card information is required to use another electronic device or to register another payment service. Whenever the user inputs the card information to register the card, the time taken to register the card may be increased, and the user may feel uncomfortable.

Various embodiments of the disclosure provided to a payment device, a payment system, and a method for registering a card, capable of registering a card based on card information, which is previously registered, by another electronic device internetworking through the same user account without receiving the card information from a user when performing card registration.

### Technical Solution

According to various embodiments of the disclosure, a first payment server may include a communication module, and a processor configured to receive a card registration request including account information from a first electronic device, to request a second payment server to provide card information on a card, which is registered by a second electronic device, in association with the account information, to receive card information from the second payment server, and to transmit, to a financial company server, the card registration request of the first electronic device based on the received card information. The first electronic device may provide a first payment service by internetworking with the first payment server through a first application, and the second electronic device may provide a second payment service by internetworking with the second payment server through a second application.

According to various embodiments of the disclosure, a method of performing card registration by a first payment server, may include receiving a card registration request including account information from a first electronic device, transmitting, to a second payment server, a request for card information on a card, which is registered by the second electronic device, in association with the account information, receiving the card information from the second payment server, and transmitting, to a financial company server, the card registration request of the first electronic device based on the received card information. The first electronic device may provide a first payment service by internetworking with the first payment server through a first application, and the second electronic device may a second payment service by internetworking with the second payment server through a second application.

According to various embodiments of the disclosure, a method for performing card registration by a payment system, may include transmitting, by a first electronic device, a card registration request including account information to a first payment server, transmitting, by the first payment server, a request for card information on a card, which is registered by the second electronic device, in association with the account information, to a second payment server, and transmitting, by the second payment server, the card information to the first payment server, transmitting, by the first payment server, the card registration request of the first electronic device to a financial company server, based on the received card information. The first electronic device may provide a first payment service by internetworking with the first payment server through a first application, and the second electronic device may a second payment service by internetworking with the second payment server through a second application.

### Advantageous Effects

According to various embodiments of the disclosure, even if the user does not directly input the card information for card registration, the card may be registered by using the card information registered by another electronic device, thereby conveniently or rapidly registering the card. Even in the state that electronic devices are not directly connected with each other through a telecommunication network, the card, which has been registered by another electronic device, may be registered based on information on the card, which is received through the server.

### DESCRIPTION OF DRAWINGS

FIG. 1 is a view illustrating a payment system, according to various embodiments of the disclosure.

FIG. 2 is a view illustrating a method for performing card registration by a payment system, according to various embodiments of the disclosure;

FIG. 3 is a flowchart illustrating a method for selecting card information, according to various embodiments of the disclosure;

FIG. 4 is a block diagram illustrating components of the first payment server, according to various embodiments of the disclosure; and

FIG. 5 is a flowchart illustrating a method for performing card registration by the first payment server, according to various embodiments of the disclosure.

### MODE FOR INVENTION

Hereinafter, various embodiments of the disclosure may be described with reference to accompanying drawings. However, those of ordinary skill in the art will understand that the disclosure is not limited to a specific embodiment, and modifications, equivalents, and/or alternatives on the various embodiments described herein can be variously made without departing from the scope and spirit of the disclosure. With regard to description of drawings, similar components may be marked by similar reference numerals.

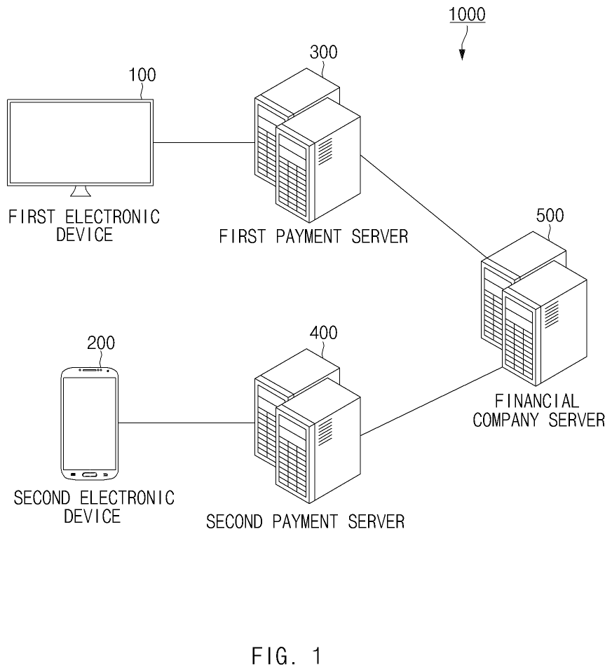

FIG. 1 is a diagram illustrating a payment system according to various embodiments of the disclosure.

Referring to 1, a payment system 1000 may include a first electronic device 100, a second electronic device 200, a first payment server 300, a second payment server 400, and a financial company server 500.

The components included in the payment system 1000 illustrated in FIG. 1 may be connected with each other through a network. For example, the first electronic device 100 and the first payment server 200 may be connected with each other through the Internet. For another example, the second electronic device 200 and the second payment server 400 may be connected with each other through a mobile communication network or the Internet.

According to an embodiment, the first electronic device 100 may provide a payment service (or a first payment service) to a user by internetworking with the first payment server 300. According to an embodiment, the second electronic device 200 may provide a payment service (or a second payment service) to the user by internetworking with the second payment server 400.

According to an embodiment, the first electronic device 100 and the second electronic device 200 may be different types of electronic devices. For example, the first electronic device 100 may be a home electronic device such as a TV or a desktop computer, and the second electronic device 200 may be a mobile device such as a smart phone, a tablet PC, or a wearable device. For example, the first electronic device 100 and the second electronic device 200 may be devices operating under different operating system environments.

According to an embodiment, the first electronic device 100 and the second electronic device 200 may provide different types of payment services. For example, the first payment service provided by the first electronic device 100 and the second payment service provided by the second electronic device 200 may be different from each other in at least some of an application, a user authentication scheme, a payment process, or an internetworking server. For example, the first electronic device 100 may provide the first payment service by internetworking with the first payment server 300 through a first application (e.g., Samsung Checkout™ Application, Pay Pal™ Application, Naver Pay™ Application, or Kakao Pay™ Application). In addition, the second electronic device 200 may provide the second payment service by internetworking with the second payment server 400 through a second application (e.g., a Samsung Pay™ Application, a PayPal™, a Naver Pay™ Application, or a Kakao Pay™ Application), which is different from the first application. In another example, the first electronic device 100 may perform user authentication using a password (e.g., a PIN code), and the second electronic device 200 may perform user authentication using biometric information (e.g., fingerprint, iris, or the like) of a user.

According to an embodiment, the first electronic device 100 and the second electronic device 200 may each provide different payment services based on the same account. For example, the first electronic device 100 and the second electronic device 200 may provide the first payment service and the second payment service based on the same service account (e.g. Samsung™ account, Pay Pal™ account, Naver™ account, Kakao™ account, or the like) provided by a payment service provider (e.g., Samsung™, a Pay Pal™, a Naver™, a Kakao™, or the like), respectively. For another example, the first electronic device 100 and the second electronic device 200 may be manufactured by the same manufacturer (e.g., Samsung™) and may provide the first payment service and the second payment service based on the same service account provided by the same manufacturer, respectively. According to an embodiment, the user of the first electronic device 100 may be the same as the user of the second electronic device 200.

According to an embodiment, the first payment server 300 may provide a payment service for the user of the first electronic device 100 by internetworking with the first electronic device 100. According to an embodiment, the second payment server 400 may provide a payment service for the user of the second electronic device 200 by internetworking with the second electronic device 200. According to an embodiment, the first payment server 300 and the second payment server 400 may store and manage information (e.g., user account information, or financial information (e.g., card information) related to a user account) associated with the payment service. According to an embodiment, the first payment server 300 and the second payment server 400 may transmit and receive information associated with the payment service together with the financial company server 500. According to an embodiment, the first payment server 300 and the second payment server 400 may be integrated into one payment server.

According to an embodiment, the financial company server 500 may be a server operated by a card issuer or a bank. According to an embodiment, the financial company server 500 may issue a card and manage financial information. According to an embodiment, when the card registration is requested by the first payment server 300, the financial company server 500 may finally determine whether to approve the card registration based on the financial information (e.g., card information) stored in the database thereof.

According to an embodiment, the financial company server 500 may generate a payment token. For example, the financial company server 500 may generate the payment token when payment (or input/withdrawal of money) is requested by the first payment server 300 or when the card registration is completed, and may transmit the payment token to the first payment server 300

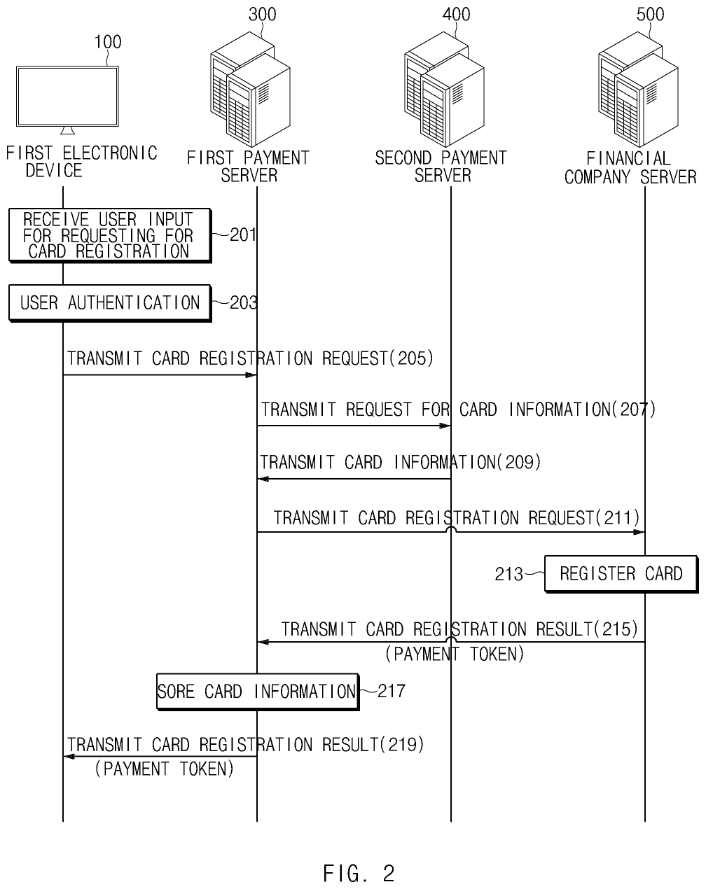

FIG. 2 is a flowchart illustrating a method for performing card registration by a payment system, according to various embodiments of the disclosure.

Referring to FIG. 2, the first electronic device 100 may receive a user input for requesting for card registration in operation 201. For example, the first electronic device 100 may receive the user input for requesting for the card registration through a user interface, which is used for the card registration, on the display. The user interface may include a menu for requesting for card information registered by another electronic device (e.g., the second electronic device) using the same account.

The first electronic device 100 may perform user authentication in operation 203. For example, the first electronic device 100 may display a user interface, which is used for the user authentication, on the display, and may receive authentication information (e.g., the PIN code) from the user through the user interface. The first electronic device 100 may perform the user authentication by comparing the authentication information input from the user with authentication information stored in the memory. The above-described user authentication procedure may be performed before the user input is received. For example, the first electronic device 100 may perform the user authentication procedure when the first application is executed, and may display the user interface for the card registration when the user authentication is completed.

The first electronic device 100 may, in operation 205, transmit, to the first payment server 300, a card registration request. The card registration request may include, for example, account information of the first electronic device 100.

When the first payment server 300 receives the card registration request from the first electronic device 100, the first payment server 300 may transmit the request for card information to the second payment server 200 in operation 207. The request for the card information may include, for example, account information of the first electronic device 100.

The second payment server 400 may transmit the card information to the first payment server 300 in operation 209. For example, the second payment server 400 may transmit, to the first payment server 300, information on at least one card registered in association with the account information included in the request for the card information. The card information may include, for example, at least one of a card issuer, a card number, a card password, an expiration date of the card, and a card validation code (CVC).

According to an embodiment, the second payment server 400 may select least one card based on a card usage history of the card registered by the second electronic device 200, and may transmit the card information of the selected card to the first payment server 300. For example, the second payment server 400 may transmit card information on a card which is the most recently used or a card having the highest use frequency, of cards registered by the second electronic device 200. The card having the highest use frequency may be, for example, a card having the largest number of use frequencies within a specified period of time.

When the first payment server 300 receives the card information from the second payment server 400, the first payment server 300 may transmit a card registration request to the financial company server 500 in operation 211. The card registration request may include the card information received from the second payment server 400.

The financial company server 500 may register the card based on the card information received from the first payment server 300 in operation 213, when the card registration request is received from the first payment server 300. For example, the financial company server 500 may determine whether all card information necessary for the card registration is received, and may compare the card information included in the card registration request with card information stored in a database to register the card.

According to an embodiment, the financial company server 500 may transmit a card registration result to the first payment server 200 in operation 215. For example, when the card registration is completed, the financial company server 500 may transmit information that the card registration is completed. For another example, the financial company server 500 may transmit information that the card registration is failed, when failing the card registration.

According to an embodiment, the financial company server 500 may generate a payment token when the card registration is complemented and may transmit the payment token together with the card registration result.

According to an embodiment, the first payment server 300 may store the card information in operation 217. For example, the first payment server 300 may store card information of the registered card in a memory (or a database), when the information that the card registration is completed is received from the financial company server 500. According to an embodiment, the first payment server 300 may store the card information with a link to the account information of the first electronic device 100.

According to an embodiment, the first payment server 300 may transmit the card registration result to the first electronic device 100 in operation 219. According to an embodiment, the first payment server 300 may transmit the payment token together with the card registration result when the payment token is received from the financial company server 500.

According to an embodiment, the first electronic device 100 may notify the card registration result to the user when the card registration result is received. For example, the first electronic device 100 may display, on the display, a user interface for notifying the card registration result.

According to the embodiment described with reference to FIG. 2, even if a user of the first electronic device 100 does not directly input the card information for card registration, the card is registered by using the card information registered by the second electronic device 200, thereby conveniently or rapidly registering the card. In particular, the convenience of the user may be increased in the case of an electronic device, such as a TV receiving a user input through a remote control, making a user uncomfortable to input the card information. Even though the card information is registered by an electronic device using another type of payment service, the card may be registered by using the previously registered card information. In addition, even if the first electronic device 100 is not directly connected with the second electronic device 200 through a telecommunication network, the first electronic device 100 may register a card, which is registered by the second electronic device 200, using information on the card, which is received through the server.

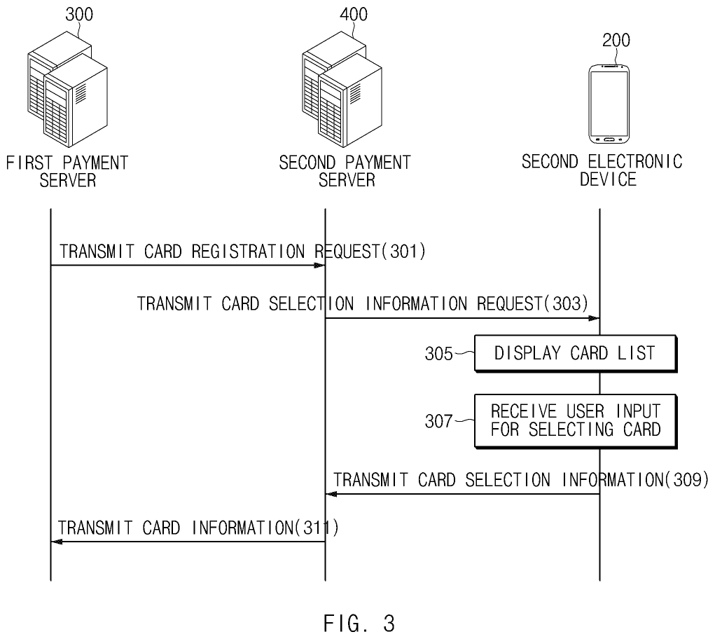

FIG. 3 is a flowchart illustrating a method for selecting card information, according to various embodiments of the disclosure.

Referring to FIG. 3, the first payment server 300 may transmit a card registration request to the second payment server 400. The card registration request may include account information of the first electronic device 100. Operation 301 performed by the first payment server 300 may correspond to operation 207 of FIG. 2, which is performed by the first payment server 300.

When receiving the card registration request from the first payment server 300, the second payment server 400 may transmit a request for card selection information to the second electronic device 200 in operation 303. For example, the second payment server 400 may identify the second electronic device 200 using the same account information as the account information of the first electronic device 100 by using the account information included in the request for the card information, and may transmit the request for the card selection information to the second electronic device 200 which is identified.

The second electronic device 200 may, in operation 305, display a user interface, which includes a card list, on the display, when the request for the card selection information is received from the second payment server 400. For example, a memory included in the second electronic device 200 may store at least some (e.g., a credit card company and a card number) of card information registered through the second payment server 200. The second electronic device 200 may display the card list based on the card information stored in the memory.

The second electronic device 200 may receive a user input for selecting a card in operation 307. For example, the second electronic device 200 may receive a user input for selecting at least one card from the card list displayed on the display.

The second electronic device 200 may transmit card selection information to the second payment server 400, in operation 309. According to an embodiment, the second electronic device 200 may transmit the card selection information based on the user input received in operation 307. The card selection information may include, for example, information (e.g., a card number) for identifying the card selected by the user.

The second payment server 400 may transmit the card information to the first payment server 300 in operation 311. According to an embodiment, the second payment server 400 may transmit card information, which corresponds to the card selection information received from the second electronic device 200, to the first payment server 300. Operation 311 performed by the second payment server 400 may correspond to operation 209 of FIG. 2, which is performed by the second payment server 400.

According to an embodiment described with reference to FIG. 3, a user may request for card registration through the first electronic device 100 in the state the user has the second electronic device 200, and may conveniently select a card to be registered through a card list displayed on the second electronic device 200.

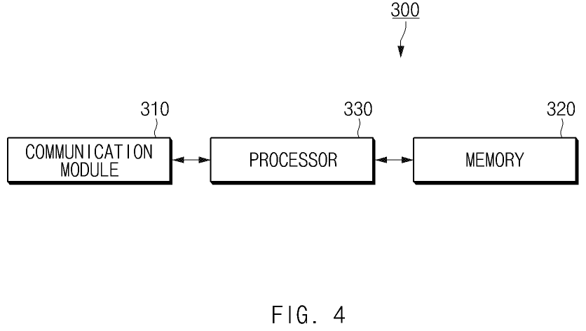

FIG. 4 is a block diagram illustrating components of the first payment server, according to various embodiments of the disclosure.

Referring to FIG. 4, the first payment server 300 may include a communication module 310, a memory (or a database) 320, and a processor 330.

According to an embodiment, the communication module 310 may make communication with an external electronic device. For example, the communication module 310 may make communication with the external electronic device (e.g., the first electronic device 100) installed with a first application to provide the first payment service. For another example, the communication module 310 may make communication with the second payment server 400, which provides the second payment service, and the financial company server 500.

According to an embodiment, the communication module 310 may transmit or receive information associated with card registration or payment, to/from the first electronic device 100, the second payment server 400 and the financial company server 500.

According to an embodiment, the memory 320 may store account information. According to an embodiment, the memory 320 may store card information associated with the account information.

According to an embodiment, the processor 330 may control the overall operation of the first payment server 400. For example, the processor 330 may register a card according to various embodiments of the disclosure, by controlling the communication module 310 and the memory 320.

According to an embodiment, the processor 330 may receive the card registration request, which includes account information, from the first electronic device 100. The card registration request may include account information of the first electronic device 100. According to an embodiment, the processor 330 may transmit the request for the card information to the second payment server 400, when receiving the card registration request from the first electronic device 100. The request for card information may include the account information of the first electronic device 100. For example, the processor 330 may request the second payment server 400 to provide card information on a card registered by the second electronic device 200 in association with the account information.

According to an embodiment, the processor 330 may receive at least one piece of card information, which is registered by the second electronic device 200, from the second payment server 400. The card information may include, for example, at least one of a card issuer, a card number, a card password, an expiration date of the card, and a card validation code (CVC).

According to an embodiment, the processor 330 may receive, from the second payment server 400, card information on a card which is the most recently used or has the highest use frequency, of cards registered by the second electronic device 200. According to an embodiment, the processor 330 may receive, from the second payment server 400, card information on a card, which is selected by a user through the second electronic device 200, of cards registered by the second electronic device 200.

According to an embodiment, when receiving the card information from the second payment server 400, the processor 330 may transmit, to the financial company server 500, a card registration request of the first electronic device 100, based on the received card information.

According to an embodiment, the processor 330 may transmit a card registration result to the first electronic device 100 when the card registration result is received from the financial company server 500. The card registration result may include information that the card registration is completed or information that the card registration is failed.

According to an embodiment, the processor 330 may store, in the memory 320, the card information with a link to the account information of the first electronic device 100 when the card registration is completed by the financial company server 500 (information that the card registration is completed is received). According to an embodiment, the processor 330 may receive the payment token from the financial company server 500 when the card registration is completed by the financial company server 500. The processor 330 may transmit, to the first electronic device 100, the payment token received from the financial company server 500.

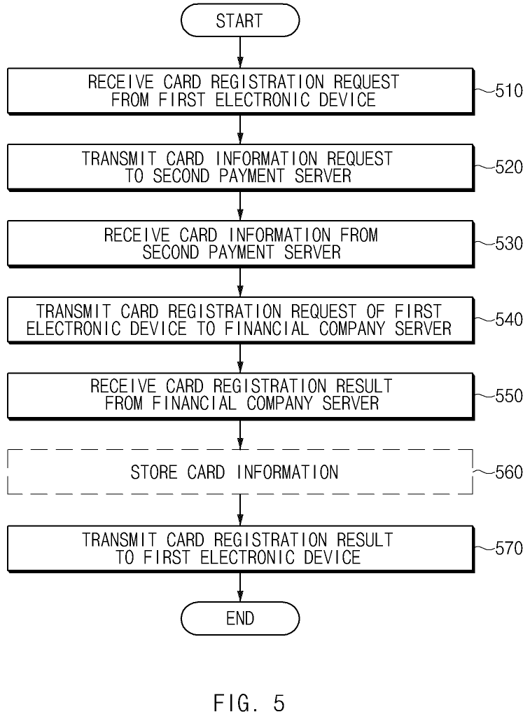

FIG. 5 is a flowchart illustrating a method for performing card registration by the first payment server, according to various embodiments of the disclosure.

The flowchart illustrated in FIG. 5 may include operations processed by the first payment server 300 illustrated in FIGS. 1 to 4. Accordingly, even if the details of the operations may be omitted from the following description, the description of the first payment server 300 made with reference to FIGS. 1 to 4 will be applied to the flowchart illustrated in FIG. 5.

Referring to FIG. 5, the first payment server 300 may receive a card registration request from the first electronic device 100 in operation 510. The card registration request may include account information of the first electronic device 100.

The first payment server 300 may transmit the request for the card information to the second payment server 400 in operation 520. The request for card information may include the account information of the first electronic device 100. For example, the first payment server 300 may request the second payment server 400 to provide card information on a card registered by the second electronic device 200 in association with the account information.

The first payment server 300 may receive information on at least one card, which is registered by the second electronic device 200, from the second payment server 400 in operation 530. The card information may include, for example, at least one of a card issuer, a card number, a card password, an expiration date of the card, and a card validation code (CVC).

According to an embodiment, the first payment server 300 may receive, from the second payment server 400, the card information on a card, which is the most recently used or has the highest use frequency, of cards registered by the second electronic device 200. According to an embodiment, the first payment server 300 may receive, from the second payment server 400, card information on a card, which is selected by a user through the second electronic device 200, of cards registered by the second electronic device 200.

The first payment server 300 may transmit, in operation 540, a card registration request of the first electronic device 100 to the financial company server 500 based on card information received from the second payment server 400.

The first payment server 300 may receive the card registration result from the financial company server 500 in operation 550. The card registration result may include information that the card registration is completed or information that the card registration is failed.

The first payment server 300 may store, in the memory, the card information with a link to the account information of the first electronic device 100 in operation 560. For example, the first payment server 300 may store the card information when the card registration is completed by the financial company server 500 (or when the information that the card registration is completed is received). When the card registration fails (or the information that the card registration is completed is received), operation 560 may be omitted.

The first payment server 300 may transmit the card registration result to the first electronic device 100 in operation 570.

According to an embodiment, the first payment server 300 may receive a payment token from the financial company server 500 when the card registration is complemented by the financial company server 500. The first payment server 300 may transmit, to the first electronic device 100, the payment token received from the financial company server 500.

At least a part of a device (e.g., modules or functions thereof) or a method (e.g., operations) according to various embodiments may be, for example, implemented by instructions stored in a computer-readable storage medium in the form of a program module. The instruction, when executed by a processor, may cause the processor to perform a function corresponding to the instruction. A computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), and an embedded memory. Also, the one or more instructions may contain a code made by a compiler or a code executable by an interpreter

While the disclosure has been shown and described with reference to various embodiments thereof, it will be understood by those skilled in the art that various changes in form and details may be made therein without departing from the spirit and scope of the disclosure as defined by the appended claims and their equivalents.

1. A first payment server comprising:
a communication module; and
a processor configured to:
receive a card registration request including account information from a first electronic device;
request a second payment server to provide card information on a card, which is registered by a second electronic device, in association with the account information;
receive card information from the second payment server; and
transmit, to a financial company server, the card registration request of the first electronic device based on the received card information,
wherein the first electronic device provides a first payment service by internetworking with the first payment server through a first application, and
wherein the second electronic device provides a second payment service by internetworking with the second payment server through a second application.

2. The first payment server of claim 1, wherein the card information includes at least one of a card issuer, a card number, a card password, an expiration date of the card, and a card validation code.

3. The first payment server of claim 1, wherein the processor is configured to:
receive a card registration result from the financial company server; and
transmit the card registration result to the first electronic device.

4. The first payment server of claim 3, further comprising:
a memory,
wherein the processor is configured to:
store, in the memory, the card information with a link to the account information when card registration is completed by the financial company server.

5. The first payment server of claim 3, wherein the processor is configured to:
receive a payment token from the financial company server when card registration is completed by the financial company server; and
transmit the payment token to the first electronic device.

6. The first payment server of claim 1, wherein the card information includes:
card information on a card, which is the most recently used, or a card, which has the highest use frequency within a specified period of time, of the card registered by the second electronic device.

7. The first payment server of claim 1, wherein the card information includes:
card information on a card, which is selected by a user through the second electronic device, of the card registered by the second electronic device.

8. A method of performing card registration by a first payment server, the method comprising:
receiving a card registration request including account information from a first electronic device;
transmitting, to a second payment server, a request for card information on a card, which is registered by a second electronic device, in association with the account information;
receiving the card information from the second payment server; and
transmitting, to a financial company server, the card registration request of the first electronic device based on the received card information,
wherein the first electronic device provides a first payment service by internetworking with the first payment server through a first application, and
wherein the second electronic device provides a second payment service by internetworking with the second payment server through a second application.

9. The method of claim 8, wherein the card information includes at least one of a card issuer, a card number, a card password, an expiration date of a card, and a card validation code.

10. The method of claim 8, further comprising:
receiving a card registration result from the financial company server; and
transmitting the card registration result to the first electronic device.

11. The method of claim 10, wherein the processor stores, in a memory, the card information with a link to the account information when card registration is completed by the financial company server.

12. The method of claim 10, further comprising:
receiving a payment token from the financial company server when card registration is completed by the financial company server; and
transmitting the payment token to the first electronic device.

13. The method of claim 8, wherein the card information includes:
card information on a card, which is the most recently used, or a card, which has the highest use frequency, of the card registered by the second electronic device.

14. The method of claim 8, wherein the card information includes:
card information on a card, which is selected by a user through the second electronic device, of the card registered by the second electronic device.

15. A method for performing card registration by a payment system, the method comprising:
transmitting, by a first electronic device, a card registration request including account information to a first payment server;
transmitting, by the first payment server, a request for card information on a card, which is registered by a second electronic device, in association with the account information, to a second payment server;
transmitting, by the second payment server, the card information to the first payment server; and
transmitting, by the first payment server, the card registration request of the first electronic device to a financial company server, based on the received card information from the second payment server,
wherein the first electronic device provides a first payment service by internetworking with the first payment server through a first application, and
wherein the second electronic device provides a second payment service by internetworking with the second payment server through a second application.
